(19) United States
(12) Patent Application Publication
(10) Pub. No.: US 2007/0279419 A1
(43) Pub. Date: Dec. 6, 2007

(54) SYSTEM AND METHOD FOR TRANSMISSION OF MESSAGES USING ANIMATED COMMUNICATION ELEMENTS

(75) Inventor: Heiko Seebach, Bretten (DE)

Correspondence Address: DARBY & DARBY P.C., P.O. BOX 770, Church Street Station, New York, NY, 10008-0770, US

(73) Assignee: ComBOTS Product GmbH, Karlsruhe (DE)

(21) Appl. No.: 11/752,389

(22) Filed: May 23, 2007

(30) Foreign Application Priority Data
May 24, 2006 (DE) 10 2006 024 449.4

(51) Int. Cl. G06T 13/00

(52) U.S. Cl. 345/473

(57) ABSTRACT

A method for receiving a message includes receiving a sent message, and ascertaining a characteristic of the message. A receipt of the message is displayed by providing a first animation allocated to an animatable figure on a display. In dependence on the ascertained characteristic, a second animation different from the first animation is provided.

This application claims priority to German Patent Application DE 10 2006 024 449.4, filed May 24, 2006, the contents of which is hereby incorporated by reference as if set forth in its entirety.

The present invention relates to a system and method for sending and receiving messages, in which the receipt of the message is displayed by an animatable communication element. In particular, the invention relates to a system and method for displaying the nature and the content of sent messages using animated communication elements.

### BACKGROUND

Traditional communication systems send messages between users over a network. Examples of such traditional communication systems are e-mail, chat, and Instant Messaging.

In JP 2003-216552, a navigation device is described which classifies different types of data which are present in a received message.

US 2004/0179039 describes a graphic user interface for an Instant Messaging system (IM system) for communication by using an avatar. The IM system is a graphic user interface, which includes an instant messaging sender display implemented on a display device for using a computer.

In WO 2005/074235, a method and a system for telecommunication between two users over a telecommunication network is described.

In the description herein, the term “messages” is meant to include all conceivable types of information which are sent between subscribers over a network. In particular, messages in this sense include texts, images, executable programs, films, and audio files or film and audio streams.

In conventional systems, in order to learn something about the content of received messages, it is necessary to open and view the messages. This can, under certain circumstances, be tiresome, time-consuming or—in the case of executable contents via which viruses can be smuggled into the system—even dangerous.

Against this background, there exists the problem of making the nature, the content, or other properties of sent messages or properties of the subscribers who are in a communication connection with the user visible to, or at least interpretable or determinable by the user of a communication system, before the user himself has to open or see all of a message from a specific subscriber.

### SUMMARY

An embodiment of the present invention provides a method for receiving a message. The method includes receiving a sent message, and ascertaining a characteristic of the message. A receipt of the message is displayed by providing a first animation allocated to an animatable figure on a display. In dependence on the ascertained characteristic, a second animation different from the first animation is provided.

### BRIEF DESCRIPTION OF THE DRAWINGS

Exemplary embodiments of the present invention are explained in more detail below with reference to the accompanying drawings, in which:

FIG. 1a illustrates a schematic representation of an exchange of messages using a system according to an embodiment of the present invention;

FIG. 1b illustrates a schematic representation of an exchange of messages using a system according to an embodiment of the present invention;

FIG. 2 illustrates a flowchart for a method according to an embodiment of the present invention; and

FIG. 3 illustrates a flowchart for a method for sending messages according to an embodiment of the present invention.

### DETAILED DESCRIPTION

In an embodiment of the present invention, the exchange of messages between subscribers to a communication system is made more vivid and informative. Upon receipt of the message, the user already receives information about the nature and content of the message, the status of the communication connection, or further interesting properties, without being forced to open the message itself. A tiresome or damaging effect of specific messages, as described above, can thereby be countered.

In particular, an embodiment of the present invention provides a method for receiving the messages, and ascertaining at least one characteristic of the message. The receipt of the message can be displayed on a display by creating an animation which is allocated to an animatable figure. Depending on the ascertained characteristic of the message, it is possible to play a different animation from the animation of the animatable figure.

In this way, it is possible to advise the receiver of the message what type of message or sent file he can expect, without the receiver himself having had to become active. If, for example, a file having an “image file” type is received, then an animation can be created which advises the receiver that an image has been received.

In a ComBOTs™ system according to the present invention, this can take place, for example, in that one or more other ComBOTs™ (i.e. other animatable figures) raises a picture frame. ComBOT™ and ComBOTs™ are trademarks of ComBOTS Product GmbH. An animation different from this could, for example, then be played if a music file has been received. In an animation designed for this, a ComBOT™ could then, for example, play a dancing animation or even emit musical sounds in addition to the animation. Many different animations, including those without avatars, are possible, such that each can be designed to suit the specific event. Thus, for example, upon receipt of a message, an animation allocated as suitable for a particular purpose corresponding to the characteristic is selected and/or played.

The file type and/or size of a file sent as a message can preferably be ascertained as a characteristic. Also, the content of the message can be determined as a characteristic. The animation can be made dependent upon the content of the message.

In an embodiment of the present invention, at least one animation which is different from the displayed figure, avatar or ComBOT™ is suggested, selected, and/or played depending on the message characteristic. Thus, the animation can be completely free and independent of the display and the functions of the ComBOT™. The animation is thus not, as is in conventional systems, tied to the properties and functionality of the avatar displayed, but can be created or selected and played free from this, so as to be best suited to the respective characteristic of the message.

Thus in an embodiment of the present invention, the animation is geared more towards the message itself than to the avatar present. In an embodiment of the present invention, the dispatcher of the message can also design or select both the message itself and also the animation accompanying the message. In contrast, in conventional systems, the dispatcher of the message influences, at most, how the already present figure is animated. In a conventional system, a message can be accompanied by an unsuitable animation of the figure, which would be disruptive if the receiver receives the message in the car or vehicle while he is driving it. The receiver's attention could be diverted in a disruptive manner by a conventional animation of the figure, in particular on mobile telecommunication terminals and navigation devices with a communication function. Moreover, in the conventional solutions the animations are related to the specific avatar, which clearly limits the possibilities for designing such animations.

According to an embodiment of the present invention, a distinction can be made between animations of the ComBOT™ per se and the others which are now selected for the message with the help of the characteristic also with regard to the time sequence. For example, upon receipt of a message, the ComBOT™ itself can be animated and another animation, different from it, which is suitably tailored to the ascertained message characteristic can then begin. In the sequence, a clear break can be inserted between the two animations, in which the ComBOT™ completely disappears and a visual and/or acoustic pointer or a symbol then appears before the start of the other animation, for example, in the form of a cloud of smoke, a flash of lightning, a puff or more of the same.

The animation of the ComBOT™ and the second animation independent of it can also be played chronologically staggered. For example, the animation of the ComBOT™ can be played upon receipt of the message, but the second animation is only played upon reading the message, i.e., not until the receiver opens the message. The second animation can be matched to the message or allocated to it, and is not linked to the figure in design or in function. Thus, the suggested animation is not limited by the figure or ComBOT™'s capabilities.

In an embodiment of the present invention, the animation is controlled by the content of the message or of the file. For example, it is possible that upon receipt of a first music file, as against the receipt of a second music file, different animations are played. As another example, upon receipt, the respective music file is played briefly for a few seconds in order to not only advise the receiver that he has received a music file, but also to actually show him which music file he has received. The receipt itself can still be displayed via an animation of the actual ComBOT™, wherein an animation depending on the characteristic of the message then follows and is played to the receiver or at least is suggested on the sender side, in order to then be played at the receiver. The animation can reproduce, for example, a suitable action. For example, it is conceivable that two or more acting figures and/or items are displayed in a type of film scene.

As another example, it is conceivable that the receiver of image files receives the sent images displayed in very small formats (e.g., as preview images or thumbnails of the original). Upon a receipt, the figure or the figures could, for example, raise a picture frame. The thumbnails of the respective image file sent could be displayed in advance in this picture frame. If film files are sent, correspondingly small preview films could also be shown.

In an embodiment of the present invention, it is provided that the animation depends solely or also additionally on the size of the file. For example, it is possible to provide different animations according to whether a sent file is a large file or a small file. Thus, the receiver of an individual small text file can be shown an animation in which, for example, a figure or a specific ComBOT™ raises a few pieces of paper into the air. Upon receipt of a further text file which is very bulky, the figure could be animated such that it drags a thick book with difficulty and thereby advises the receiver not only that he has received a text file, but also that in this case it is a bulky text file. Thus, the embodiment of the present invention also reinforces the effect upon the receiver through the intelligently-controlled animation which suits the ascertained characteristic.

For example, the message can be received by a communication system such as a ComBOT™, e-mail or chat session. The message is preferably sent via the developed ComBOTS™ system in which there is an exclusive connection between two communication partners and an avatar or ComBOT™ is allocated to the respective other communication partner. Ideally, in the ComBOTS™ communication system, the messages or data are sent via secured private communication channels, where the respective ComBOT™ has no public address via which it could be reached by a third party.

As has already been mentioned above, a ComBOT™ is a communication element which exclusively represents the other communication partner and makes it available on his own display, such as the screen or display of the actual PC. By mouse movement, in particular by dragging and dropping files, a ComBOT™ can be sent to the other communication partner. A further ComBOT™ is displayed for every further communication partner. Thus, in the present invention, a ComBOT™ represents a specific communication partner and can be animated individually upon receipt of messages or files. Further, in an embodiment of the present invention, the receiver can first be advised by the animation of the ComBOT™ that the corresponding communication partner to whom this ComBOT™ is allocated has let him have a message. Additionally, the receiver can also be shown, by the new, preferably a specifically designed, animation dependent on the characteristic of the message, what type of file it is and/or also what the content of the message or file is and/or what size the file is.

In an embodiment of the present invention, the animation is preferably predefined and/or selected by a user. This can be the sender to whom, before or while dispatching the message, a selection of suitable animations is suggested. As an example, the sender may wish to send the receiver a message in which is written “I love you”. The method or system recognizes this message content and suggests to the sender several animations allocated to this such as flying hearts, cooing doves, kissing couples, etc. The selection can be displayed in the form of a so-called picker, i.e., a selection display with thumbnails or small previews of the suggested animations.

In an embodiment of the present invention, an audio signal is created or played within or in addition to the animation. In addition to the graphic animation, which, for example, can take place by video sequences, audio signals can also be used additionally or exclusively. For example, it is possible to play specific tone sequences according to the type of received file, content of the received file, or size of the file. In particular, it is preferable with music or sound files that the content of the file can be played partially (as an intro) or also in full.

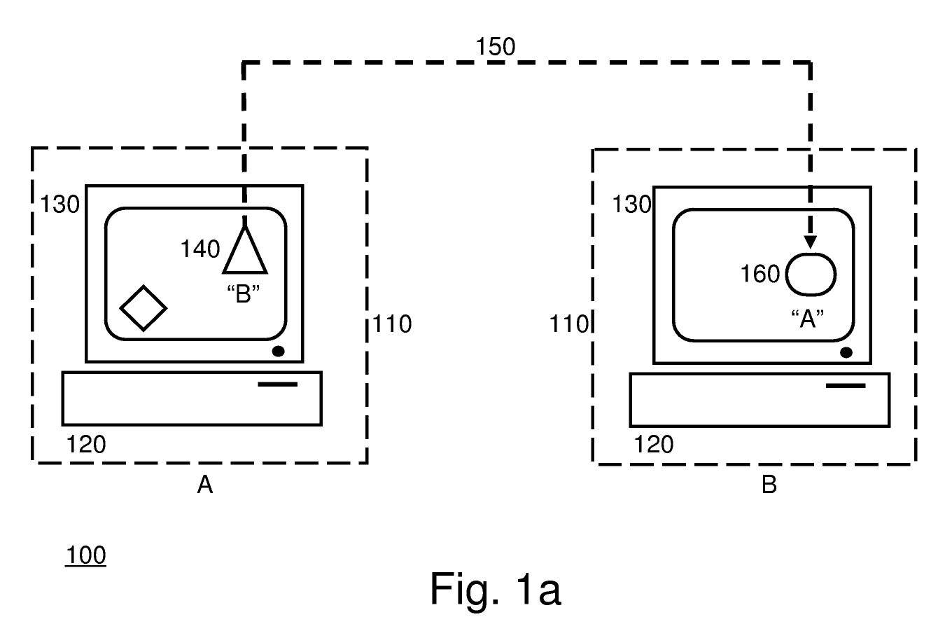

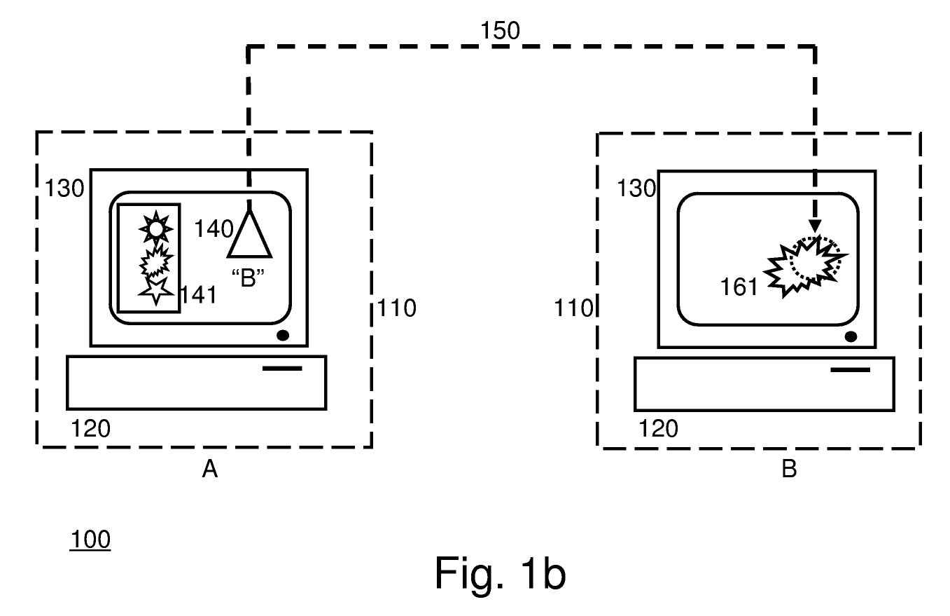

FIG. la shows a schematic representation of the exchange of messages using devices 110 according to an embodiment of the present invention. The respective device 110 serves as a terminal for the respective user A, B or for the respective communication partner A, B. In the example illustrated in FIG. 1, the first user A wishes to send a message to the second user B. Communication devices 110 can be, for example, personal computers 110 which each comprise respectively a display, here a screen 130, and respectively a memory and arithmetic-logic unit, represented here by the respective computer 120, and inputs and outputs for constructing communication connections 150 with further devices 110. It is to be understood that other communication devices capable of communication, such as terminals, handhelds, etc., can also be used as devices 110.

The communication connection 150 is conducted via a network or communication system. Transmission can be achieved with any protocols via any known medium. In the example shown here, the TCP/IP protocol and the Internet are preferably used to construct the communication connection 150.

The respective device or the terminal 110 can store, in the memory and arithmetic-logic unit 120 for its user or subscriber, the subscriber data which make possible the construction of the communication connection 150 to the desired subscriber or communication partner. For example, a connection 150 is constructed from the computer of user A shown on the left in FIG. la to the computer of user B shown on the right. The subscriber data serve, in particular, to identify or authenticate the user vis-à-vis the communication system. The subscriber data do not have to be stored on the respective computer 120, but can also be, at least partially, stored in the communication system itself. The subscriber data can comprise an e-mail address of the subscriber, an IP address, or also a user recognition for a chat system (e.g., login, nickname).

In addition to the subscriber data, the device or the terminal 110 can store, in the memory and arithmetic-logic unit for every subscriber, in particular for every communication partner, one or more communication elements 140 or 160 which appear as graphic elements. The graphic elements are represented, in particular, as animatable figures or icons on the respective screen, in particular on the user interface of the terminal 110.

In the example, ComBOT™ “B” appears on the screen or desktop of user A in the form of an animal figure “dog”. ComBOT™ “A” appears on the desktop of user B in the form of a comic figure “Donald”. These communication elements 140 or 160 can be displayed graphically as individual pixel graphics, preferably also as sequences of pixel graphics, and can be animated upon receipt of messages. The actual transmission of the message takes place in a very user-friendly manner via the communication elements, i.e., here via the ComBOTs™, which each represent a specific subscriber as communication partner for the other. In other words the communication element can, because of the allocation to a specific subscriber, act as what a specialist would call his ‘avatar’.

For example, the icon or the avatar of a specific subscriber can be displayed on the display or the screen 130 of the terminal 110. The subscriber or the user of this terminal 110 can then, for example, with an input device such as a mouse, select the ComBOT™ in order to start or prompt the construction of a communication connection 150 with the subscriber or communication partner who is represented by the ComBOTs™ figure, icon or avatar. Also, by dragging a file onto the icon using the mouse, any desired action of the device can generally be triggered, for example, sending the file to the user whom the icon represents.

The ComBOTs™ icons or avatars which identify individual subscribers can all be different. The ComBOTs™ can be placed at any point on the screen. As is shown in FIG. 1a, a ComBOT™ 140, here symbolized by a triangle and a name badge “B”, which represents the communication partner, i.e., user B on the right-hand screen, is located on the left-hand screen of the one user A. There in turn, a ComBOT™ 160, here in the form of an oval, which represents the other user A, is shown in turn on the right-hand screen. The “triangle” or “oval” symbols here stand, by way of example, for animatable figures such as animal figures or fantasy figures (e.g., monsters, etc.) which can be animated upon receipt of a message.

FIG. 1b shows an arrangement similar to that illustrated in FIG. 1a. Here in FIG. 1b, the system suggests or shows to the dispatcher or sender of the message animations from which the sender can select in order to show, or have played, an animation of same receiver-side to the receiver.

If the first user or sender A now wishes to send, for example, a text message to the second user or receiver B, the sender A firstly enters the text for the message in a corresponding input or editing window. In an embodiment of the present invention, the computer 120 and/or the system recognizes, in the message text, specific words, sequences of letters or strings, and/or so-called key combinations, shortcuts , or character sequences which characterize the message. Examples of such include “love” or the character sequence “:)”. Then, via access to a database, animations suitable for the recognized message text are sought and suggested or displayed to the sender A in the form of a selection 141. Such a selection 141, which can comprise symbols or preview images (e.g., thumbs, thumbnails, previews, etc.) for the different animations, is displayed. In FIG. 1b, the selection 141 is represented by a window with three symbols. Sender A can select from one or optionally more animations which are then sent to the receiver B with the message, or at least logically connected to the message.

For example, sender A is shown a selection 141 in the form of a so-called picker from which he can select by clicking on his mouse or by dragging & dropping onto the ComBOT™ “B”. This animation is then sent in conjunction with the actual message transmission. If, for example, the word or keyword “surprise” has been used in the message, the system suggests several suitable animations such as “bright comet passes across the starry sky”, “jagged cloud glitters colourfully”, or “magician waves his wand”, etc. The sender A can then select the animation that he would like to send to the receiver B. With the receipt of the message, or preferably not until the receiver opens or reads the message, the selected animation 161 is then played on the receiver side. The suggestion and optionally even the selection can also take place in a system-controlled manner according to parameters which are stored for the user(s), preferably in corresponding user profiles.

Such parameters can be, for example, sex, origin or country of the user, applicable tariff for the communication service, etc. The animations can also be purchased in an online shop, whereby the user acquires specific rights to use such animations. These also can be parameters which the system evaluates upon the production of an animation suggestion.

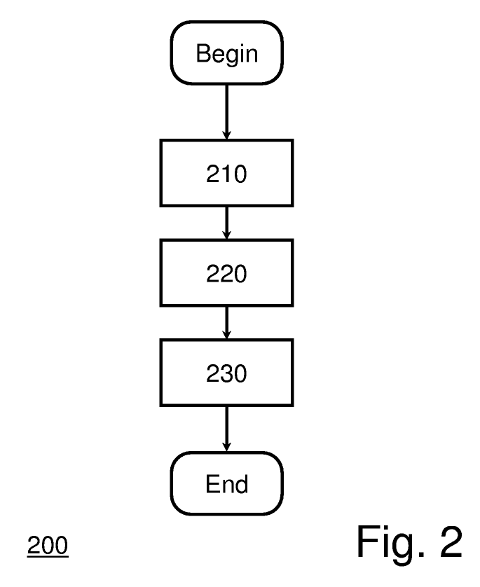

FIG. 2 shows a flowchart for a method 200 for receiving messages according to an embodiment of the present invention.

In step 210, a message is received which comprises, for example, a file. The actual receipt of the message can take place via a communication connection 150, as shown in connection with FIG. 1, and can be displayed by an animation of the receiver-side ComBOT™.

The animation dependent on the characteristic of the message can take place then or later in a system-controlled or at least system-supported manner. For this, in step 220, at least one characteristic of the message and/or of the file is ascertained. In this context, a “characteristic” includes any property which can be analyzed technically and which can serve as a distinction criterion in order to distinguish the message or the file from others. Examples of characteristics are: file type, file size, text format, message length, send time or transmission path, etc. The at least one characteristic can be a property which is predefined, for example, according to a technical definition or a standard such as, say, MP3 or JPG. It can also be a property predefined by manufacturers or service providers, such as, for example, PDF or CSV. It can also be a property predefined by the user, such as file name begins with “April . . . ” or file date lies between Jan. 1, 2006 and Mar. 31, 2006, etc. Both the receiver (i.e., user who receives the message) and the sender can predefine specific properties, in particular also combinations thereof, such as, for example, message is a text message and contains the word “today”. The property can also be a property predefined by the system, such as, for example, file received not more than 30 minutes ago.

For example, in step 220 the type of message or file is analyzed. The type analysis takes place such that it is automatically established whether, for example, it is a text message, a graphics file, an audio file, or similar.

Then, in step 230, depending on the type of message established, at least one allocated or suitable animation is suggested and/or displayed on the receiver's display. For example, if it is established in step 220 that the message is a graphics file, in particular a photo file, an animation can be suggested or displayed in which a figure, for example, a specific ComBOT™, glues a picture into a photo album in order to inform the user that the sent message is a graphics file or photo file.

The animation, dependent in each case on the ascertained characteristic, can also be predefined by the user, preferably by the receiver, or by the system. If the message contains e.g. the word “today”, then a suitable animation for this is started which the receiver has selected, such as e.g. an animation in which the ComBOT™ pulls a pocket watch from his trouser pocket and points to this pocket watch. If the message relates to an appointment, such as e.g. “meeting today at 1 p.m.”, then precisely this time is preferably also displayed on the pocket watch. The text is analyzed e.g. via a technical text recognition (so-called text parsing). It is equally possible that the system recognizes specific keyboard inputs as so-called shortcuts and suggests corresponding animations.

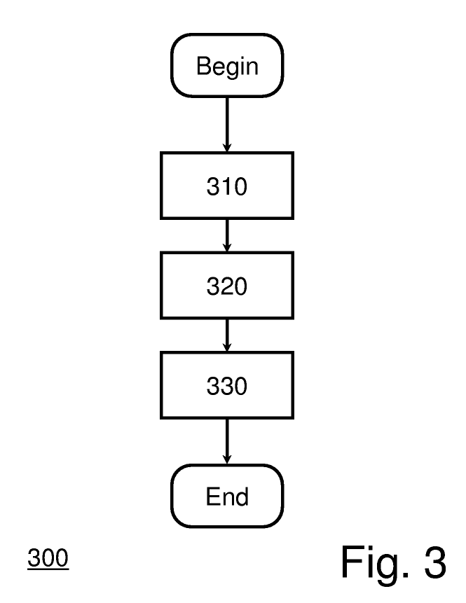

FIG. 3 shows a flowchart for a method 300 for sending messages according to an embodiment of the present invention.

In step 310, a reference or a link to a file, a file name, or the file itself is received. This step is somewhat analogous to that of the receipt of a message via a network connection. However, here in the present embodiment example according to FIG. 2, it is assumed that, for example, the transmitting user uses ‘drag & drop’ to ‘drag’ a file onto a ComBOT™ which is located on the desktop of the user.

In step 320, which is somewhat analogous to step 220 in FIG. 2, the type of file is analyzed. In other words, it is established whether the file is e.g., a graphics, an audio, or other type of file.

In step 330, which is somewhat analogous to step 230 in FIG. 2, depending on the established message type, an icon or an animation is selected and displayed from among the icons or animations stored for the specific subscriber. For example, if it has been established in step 320 that the message is a graphics file, an animation can be displayed in which a figure glues a picture into an album in order to inform the user that the sent message is a graphics file.

The method shown in FIG. 3 can continue, after the selection and display of an animation allocated to a specific file type, with the dispatch of the file received via ‘drag & drop’ to the subscriber who is represented by the selected avatar.

In addition to the file type, the selection of a subscriber-specific animation in steps 230 and 330, respectively in FIG. 2 and FIG. 3, can be made dependent on the nature of the data or file, on the file size, on the production date, on the production location, on the production system, on the author, and on a number of further file properties familiar to a person skilled in the art, in order to inform the user of these properties through animation or to entertain him while sending a file.

In this way, the present invention provides a system and method with which additional information about the received messages is made visible or interpretable to receivers of messages without the message having had to be already opened.

While the invention has been particularly shown and described with reference to preferred embodiments thereof, it will be understood by those skilled in the art that various changes in form and details may be made therein without departing from the spirit and scope of the invention.

What is claimed is:

1. A method for receiving a message, the method comprising:
receiving a sent message;
ascertaining a characteristic of the message;
displaying a receipt of the message by providing a first animation allocated to an animatable figure on a display; and
providing, depending on the ascertained characteristic, a second animation different from the first animation.

2. The method as recited in claim 1, wherein the providing the second animation includes at least one of predefining and playing the second animation.

3. The method as recited in claim 1, wherein
the message comprises a file;
the ascertained characteristic is related to at least one of a size of the file and a type of the file; and
the second animation depends on at least one of the ascertained file size and ascertained file type.

4. The method as recited in claim 1, wherein:
the ascertained characteristic relates to a content of the message, and
the second animation depends on the ascertained content of the message.

5. The method as recited in claim 1, wherein:
the message comprises a plurality of files;
the ascertained characteristic relates to a number of files in the message; and
the second animation depends on the ascertained number of files.

6. The method as recited in claim 5, wherein:
the plurality of files include at least one of different file types and different file sizes; and
the ascertained characteristic relates to at least one of a number of files of similar file type and similar file size.

7. The method as recited in claim 1, wherein the receiving the sent message is performed using at least one of a ComBOT™, e-mail, and chat session communication.

8. The method as recited in claim 1, wherein the providing a second animation comprises providing an audio signal.

9. The method as recited in claim 8, wherein the message comprises a file, and the providing an audio signal comprises playing a content of the file.

10. The method as recited in claim 9, wherein the playing a content of the file comprises playing the content of the file for a predefined time.

11. The method as recited in claim 1, wherein the second animation is at least one of predefined and selected by a user.

12. The method as recited in claim 1, further comprising predefining the second animation by a communication system from which the message is sent.

13. A communications device comprising:
a display operable to display a receipt of a sent message by providing a first animation allocated to an animatable figure on the display; and
a memory and arithmetic-logic unit operable to ascertain a characteristic of the message, and provide, depending on the ascertained characteristic, a second animation different from the first animation.

14. The device as recited in claim 13, wherein the memory and arithmetic-logic unit is operable to provide the second animation by predefining and playing the second animation.

15. The device as recited in claim 13, wherein
the message comprises a file;
the ascertained characteristic is related to at least one of a size of the file and a type of the file; and
the memory and arithmetic-logic unit is operable to provide the second animation in dependence on at least one of the ascertained file size and ascertained file type.

16. The device as recited in claim 13, wherein:
the ascertained characteristic relates to a content of the message, and
the memory and arithmetic-logic unit is operable to provide the second animation in dependence on the ascertained content of the message.

17. The device as recited in claim 13, wherein:
the message comprises a plurality of files;
the ascertained characteristic relates to a number of files in the message; and
the memory and arithmetic-logic unit is operable to provide the second animation in dependence on the ascertained number of files.

18. The device as recited in claim 13, wherein the memory and arithmetic-logic unit is operable to receive the sent message using at least one of a ComBOT™, e-mail, and chat session communication.

19. A communication system for receiving a message, the system comprising:
a communication device operable to receive a sent message;
a display operable to display a receipt of the message by providing a first animation allocated to an animatable figure on the display; and
a memory and arithmetic-logic unit operable to ascertain a characteristic of the message, and provide, depending on the ascertained characteristic, a second animation different from the first animation.

20 . The system as recited in claim 19, wherein the memory and arithmetic-logic unit is operable to provide the second animation by predefining and playing the second animation.
